(19) United States
(12) Patent Application Publication
(10) Pub. No.: US 2010/0060669 A1
(43) Pub. Date: Mar. 11, 2010

(54) BRIGHTNESS-ADJUSTING DEVICE AND METHOD FOR DISPLAY SCREENS

(75) Inventor: SEN-HSIANG CHENG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/391,347

(22) Filed: Feb. 24, 2009

(30) Foreign Application Priority Data
Sep. 9, 2008 (CN) 200810304430.7

(51) Int. Cl. G09G 5/10

(52) U.S. Cl. 345/690

(57) ABSTRACT

A brightness-adjusting device and method for a display screen are described. Depending upon the brightness of ambient light, the display screen is either brightened or darkened and powered by either a solar cell or battery.

### BACKGROUND

1. Technical Field

The present disclosure relates to a brightness-adjusting device for display screen and adjusting method thereof.

2. Description of Related Art

Usually, display screens of portable electronic devices (e.g., mobile phones and digital cameras) appear dim under strong light, e.g., sunlight. Thus, a brightness-sensing device is typically mounted within the portable electronic device for automatically increasing or decreasing display screen brightness according to light conditions.

However, the display screen together with the brightness-sensing device consume a lot of battery energy, shortening stand-by time of the portable electronic device.

Therefore, there is room for improvement within the art.

### BRIEF DESCRIPTION OF THE DRAWINGS

Many aspects of a brightness-adjusting device for a display screen can be better understood with reference to the following drawings. These drawings are not necessarily drawn to scale, the emphasis instead being placed upon clearly illustrating the principles of the present brightness-adjusting device for display screen. Moreover, in the drawings like reference numerals designate corresponding sections throughout the several views.

FIG. 1 is a block diagram showing a brightness-adjusting device for display screen, in accordance with an exemplary embodiment.

FIG. 2 is a flow-chart showing a brightness adjusting method for display screen, in accordance with an exemplary embodiment.

### DETAILED DESCRIPTION OF EXEMPLARY EMBODIMENT

The present brightness-adjusting device is used in a portable electronic device, such as a mobile phone or personal digital assistant (PDA).

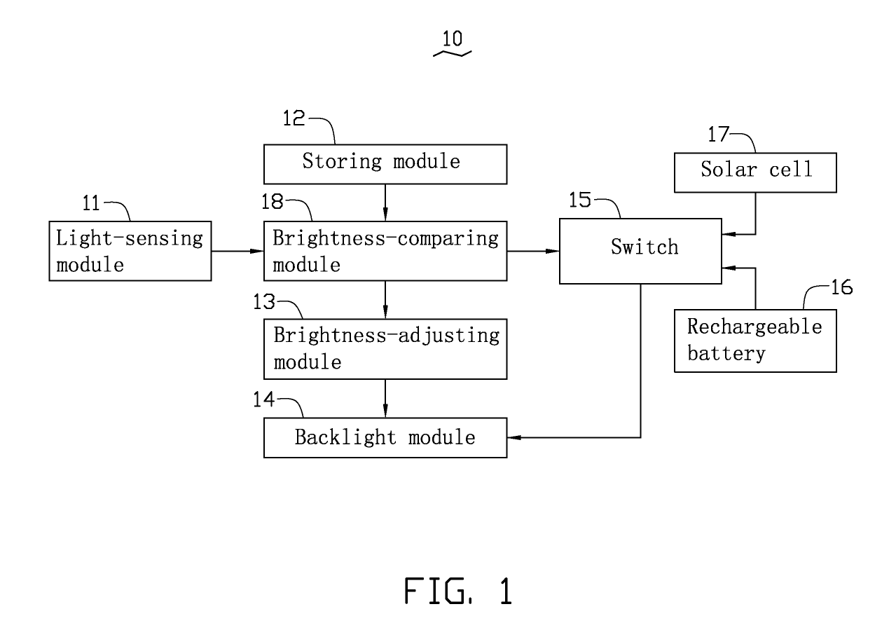

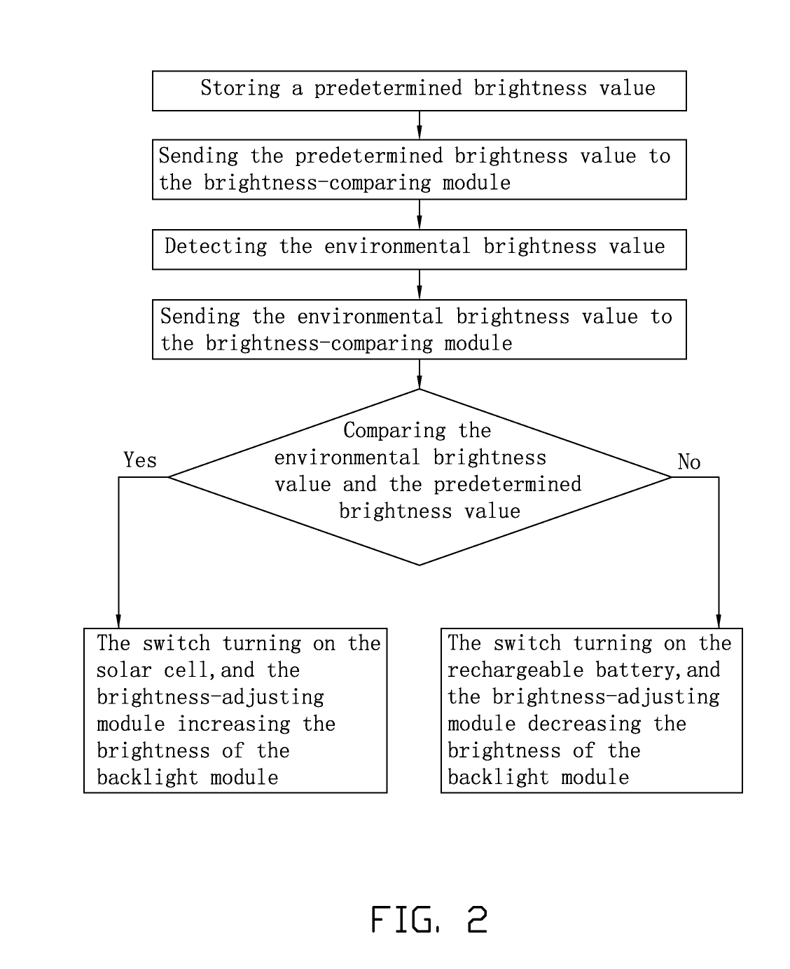

Referring to FIGS. 1 and 2, the brightness-adjusting device 10 is shown. The brightness-adjusting device 10 includes a light-sensing module 11, a storing module 12, a brightness-adjusting module 13, a backlight module 14, a switch 15, a rechargeable battery 16, a solar cell 17, and a brightness-comparing module 18.

The rechargeable battery 16 and the solar cell 17 are electronically connected to the backlight module 14 by the switch 15. The input end of the brightness-comparing module 18 is electronically connected to the light-sensing module 11 and the storing module 12. The output end of the brightness-comparing module 18 is electronically connected to the brightness-adjusting module 13 and the switch 15.

The light-sensing module 11 detects the ambient brightness value. The storing module 12 stores a predetermined brightness value. The predetermined brightness value can be changed according to users' requirements. The brightness-adjusting module 13 adjusts the brightness of the backlight module 14.

The backlight module 14 is mounted within the portable electronic device for providing sufficient light to illuminate the display screen. The switch 15 switches the rechargeable battery 16 and the solar cell 17 on or off. The rechargeable battery 16 may be a Ni-Mh rechargeable batteries or a lithium-ion rechargeable battery. The solar cell 17 transforms solar energy into electrical energy.

The brightness-comparing module 18 compares the ambient brightness value and the predetermined brightness value, transforms the result into an electrical signal, and sends the electrical signal to the brightness-adjusting module 13 and the switch 15.

In the method of FIG. 2, which may be carried out using the device 10, begins a predetermined brightness value is stored in the storing module 12 and sent to the brightness-comparing module 18. The light sensing-module 11 detects an ambient brightness value and sends the ambient brightness value to the brightness-comparing module 18. Then, the brightness-comparing module 18 compares the ambient brightness value with the predetermined brightness value, and transforms the result into an electrical signal, and sends the electrical signal to the brightness-adjusting module 13 and the switch 15. If the ambient brightness value is higher than the predetermined brightness value, the switch 15 turns on the solar cell 17, and the brightness-adjusting module 13 increases the brightness of the backlight module 14. If the ambient brightness value is lower than or equal to the predetermined brightness value, the switch 15 turns on the rechargeable battery 16, and the brightness-adjusting module 13 maintains or decreases the brightness of the backlight module 14 accordingly.

The brightness-adjusting device 10 for a display screen can increase the brightness of the backlight module 14, e.g., under strong sunlight. At this time, the switch 15 turns on the solar cell 17 instead of the rechargeable battery 16 for the portable electronic device, thereby prolonging working time of the rechargeable battery 16.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of sections within the principles of the invention to the full extent indicated by the broad general meaning of the terms, in which the appended claims are expressed.

What is claimed is:

1. A brightness-adjusting device for a display screen comprising:
a light-sensing module for sensing an ambient brightness value;
a storing module for storing a predetermined brightness value;
a rechargeable battery;
a solar cell;
a switch;
a backlight module electronically and selectedly connected to the rechargeable battery and solar cell by the switch; and
a brightness-comparing module, an input end of the brightness-comparing module being electronically connected to the light-sensing module and the storing module, an output end of the brightness-comparing module being electronically connected to the switch, the brightness-comparing module comparing the ambient brightness value with the predetermined brightness value and transforming a comparing result into corresponding electrical signal, which is sent to the switch to turn on one of the rechargeable battery or solar cell.

2. The brightness-adjusting device for a display screen as claimed in claim 1, further including a brightness-adjusting module, wherein the input end of the brightness-adjusting module is electronically connected to the output end of the brightness-comparing module and the output end of the brightness-adjusting module is electronically connected to the backlight module, the brightness-adjusting module is used to adjust the brightness of the backlight module.

3. The brightness-adjusting device for a display screen as claimed in claim 1, wherein the rechargeable battery is a Ni-Mh rechargeable battery or a lithium-ion rechargeable battery.

4. A method of adjusting the brightness of a display screen, comprising:
storing a predetermined brightness value;
sensing an ambient brightness value;
comparing the ambient brightness value with the predetermined brightness value;
whereby:
if the ambient brightness value is higher than the predetermined brightness value, a solar cell is used to power the display screen; and
if the ambient brightness value is lower than or equal to the predetermined brightness value, a battery is used to power the display screen.

5. The adjusting method of claim 4, further comprising the step of: increasing the brightness of the display screen if the ambient brightness value is higher than the predetermined brightness value and decreasing the brightness of the display screen if the ambient brightness value is lower than or equal to the predetermined brightness value.
